(19) United States
(12) Patent Application Publication
(10) Pub. No.: US 2019/0141320 A1
(43) Pub. Date: May 9, 2019

(54) ENHANCED REFERENCE PICTURE MANAGEMENT IN VIDEO CODING

(71) Applicant: QUALCOMM Incorporated, San Diego, CA (US)

(72) Inventors: Ye-Kui WANG, San Diego, CA (US); Wei-Jung CHIEN, San Diego, CA (US); Yi-Wen CHEN, San Diego, CA (US); Marta KARCZEWICZ, San Diego, CA (US)

(21) Appl. No.: 16/182,364

(22) Filed: Nov. 6, 2018

Related U.S. Application Data
(60) Provisional application No. 62/582,585, filed on Nov. 7, 2017.

(51) Int. Cl. H04N 19/115; H04N 19/137; H04N 19/177; H04N 19/172

(52) U.S. Cl. CPC H04N 19/115; H04N 19/172; H04N 19/177; H04N 19/137

(57) ABSTRACT

A coding device configured to code video data that includes a buffer memory configured to store pictures of the video data and a at least one processor implemented in circuitry that is in communication with the buffer memory such that the processor is configured to code at least two pictures of a single coded video sequence (CVS) of the video data where each picture of the at least two pictures is associated with an identical picture order count (POC) value and where the at least two pictures are different from one another, associate respective data with each of the at least two pictures of the single CVS, and identify, for inclusion in a reference picture set, at least one picture among the at least two pictures based on the identical POC value associated with the at least two pictures and the respective data associated with the at least one picture.

This application claims the benefit of U.S. Provisional Application No. 62/582,585, filed Nov. 7, 2017, the entire content of which is hereby incorporated by reference.

### TECHNICAL FIELD

This disclosure relates to video encoding and/or video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 or ISO/IEC MPEG-4 AVC, including its scalable video coding and multiview video coding extensions known respectively as Scalable Video Coding (SVC) and Multiview Video Coding (MVC), and High-Efficiency Video Coding (HEVC) also known as ITU-T H.265 and ISO/IEC 23008-2, including its scalable coding extension (i.e., scalable high-efficiency video coding, SHVC), multiview extension (i.e., multiview high efficiency video coding, MV-HEVC), fidelity range extension, 3D extension (i.e., 3D-HEVC), and screen content coding extension. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques and/or mechanisms for enhancing reference picture management by, for example, enabling multiple, different pictures having a same (e.g., identical) picture order count (POC) value to be present (e.g., stored) in a decoded picture buffer (DPB) at the same time (e.g., simultaneously) and used for inter-prediction and furthermore enabling POC based scaling of motion vectors and/or sample values.

In one example, a method of coding video data includes coding, by a coding device including a processor implemented in processing circuitry, at least two pictures of a single coded video sequence (CVS) of the video data where each picture of the at least two pictures is associated with an identical picture order count (POC) value, the at least two pictures being different from one another, associating, by the coding device, respective data with each of the at least two pictures of the single CVS, and identifying, by the coding device for inclusion in a reference picture set, at least one picture among the at least two pictures based on the identical POC value associated with the at least two pictures and the respective data associated with the at least one picture.

In another example, a coding device for coding video data includes a buffer memory configured to store pictures of the video data and at least one processor, implemented in circuitry, that is in communication with the buffer memory and is configured to code, at least two pictures of a single coded video sequence (CVS) of the video data where each picture of the at least two pictures is associated with an identical picture order count (POC) value, the at least two pictures being different from one another, associate respective data with each of the at least two pictures of the single CVS, and identify, for inclusion in a reference picture set, at least one picture among the at least two pictures based on the identical POC value associated with the at least two pictures and the respective data associated with the at least one picture.

In yet another example, an apparatus configured to code video data includes means for storing pictures of the video data, means for coding, at least two pictures of a single coded video sequence (CVS) of the video data where each picture of the at least two pictures is associated with an identical picture order count (POC) value, the at least two pictures being different from one another, means for associating respective data with each of the at least two pictures of the single CVS, and means for identifying, for inclusion in a reference picture set, at least one picture among the at least two pictures based on the identical POC value associated with the at least two pictures and the respective data associated with the at least one picture.

In yet another example, a computer-readable storage medium stores instructions that, when executed, causes at least one processor configured to code video data to code at least two pictures of a single coded video sequence (CVS) of the video data, wherein each picture of the at least two pictures is associated with an identical picture order count (POC) value, the at least two pictures being different from one another; associate respective data with each of the at least two pictures of the single CVS; and identify, for inclusion in a reference picture set, at least one picture among the at least two pictures based on the identical POC value associated with the at least two pictures and the respective data associated with the at least one picture.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system configured to implement the techniques of the disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 is a flowchart illustrating example operations of a video encoder operating in accordance with the enhanced reference picture management mechanism(s) of this disclosure.

FIG. 5 is a flowchart illustrating example operations of a video decoder operating in accordance with the enhanced reference picture management mechanism(s) of this disclosure.

### DETAILED DESCRIPTION

This disclosure is related to the field of coding of video signals. More specifically, the techniques of this disclosure include several exemplary mechanisms to enhancing reference picture management. For example, the disclosure includes techniques and/or mechanisms to enabling multiple, different pictures having a same (e.g., identical) picture order count (POC) value to be present (e.g., stored) in a decoded picture buffer (DPB) at the same time (e.g., simultaneously). Furthermore, in accordance with this disclosure, these multiple pictures that are simultaneously present in a DPB may be used for inter-prediction as well as POC-based scaling of associated motion vectors and/or sample values.

The techniques of this disclosure may be used with any of the existing video codecs, such as High Efficiency Video Coding (HEVC), or be an efficient coding tool in any future video coding standards, such as H.266/Versatile Video Coding(VVC).

Various techniques in this disclosure may be described with reference to a video coder, which is intended to be a generic term that can refer to either a video encoder or a video decoder. Unless explicitly stated otherwise, it should not be assumed that techniques described with respect to a video encoder or a video decoder cannot be performed by the other of a video encoder or a video decoder. For example, in many instances, a video decoder performs the same, or sometimes a reciprocal, coding technique as a video encoder in order to decode encoded video data. In many instances, a video encoder also includes a video decoding loop, and thus the video encoder performs video decoding as part of encoding video data. Thus, unless stated otherwise, the techniques described in this disclosure with respect to a video decoder may also be performed by a video encoder, and vice versa.

This disclosure may also use terms such as current layer, current block, current picture, current slice, etc. In the context of this disclosure, the term current is intended to identify a layer, block, picture, slice, etc. that is currently being coded (e.g., encoded or decoded), as opposed to, for example, previously coded layers, blocks, pictures, and slices or yet to be coded blocks, pictures, and slices.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its scalable video coding extension known as SVC and its multi-view video coding extension known as MVC.

In addition, there is a newly developed video coding standard, namely High Efficiency Video Coding (HEVC), also referred to as ITU-T H.265, developed by the Joint Collaboration Team on Video Coding (JCT-VC) of ITU-T Video Coding Experts Group (VCEG) and ISO/IEC Motion Picture Experts Group (MPEG). A recent draft of HEVC is available from http://phenix.int-evry.fr/jct/doc_end_user/documents/12_Geneva/wg11/JCTVC-L1001-v32.zip.

Video coding standards, including hybrid-based video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions. The design of a new video coding standard, namely HEVC, has been finalized by the Joint Collaboration Team on Video Coding (JCT-VC) of ITU-T Video Coding Experts Group (VCEG) and ISO/IEC Motion Picture Experts Group (MPEG). An HEVC draft specification referred to as HEVC Working Draft 10 (WD10), Bross et al., “High efficiency video coding (HEVC) text specification draft 10 (for FDIS & Last Call),” Joint Collaborative Team on Video Coding (JCT-VC) of ITU-T SG16 WP3 and ISO/IEC JTC1/SC29/WG11, 12th Meeting: Geneva, CH, 14-23 January 2013, JCTVC-L1003v34, is available from http://phenix.int-evry.fr/jct/doc_end_user/documents/12_Geneva/wg11/JCTVC-L1003-v34.zip. The finalized HEVC standard is referred to as HEVC version 1.

A defect report, Wang et al., “High efficiency video coding (HEVC) Defect Report,” Joint Collaborative Team on Video Coding (JCT-VC) of ITU-T SG16 WP3 and ISO/IEC JTC1/SC29/WG11, 14th Meeting: Vienna, AT, 25 July-2 Aug. 2013, JCTVC-N1003v1, is available from http://phenix.int-evry.fr/jct/doc_end_user/documents/14_Vienna/wg11/JCTVC-N1003-v1.zip. The finalized HEVC standard document is published as ITU-T H.265, Series H: Audiovisual and Multimedia Systems, Infrastructure of audiovisual services—Coding of moving video, High efficiency video coding, Telecommunication Standardization Sector of International Telecommunication Union (ITU), April 2013, and another version was published in October 2014.

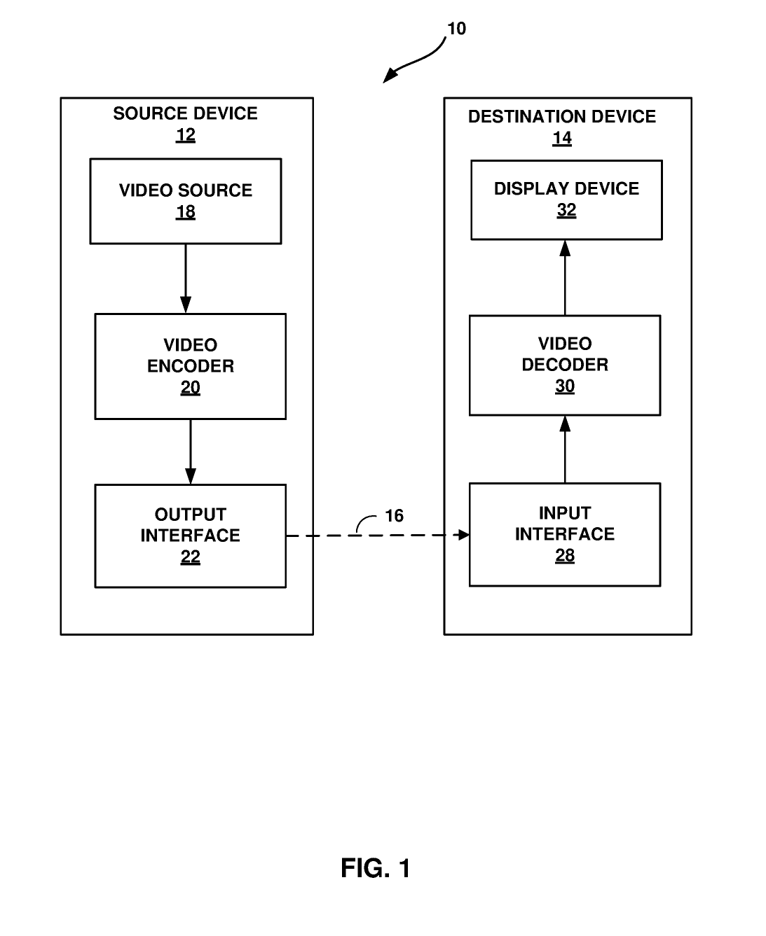

FIG. 1 is a block diagram illustrating an example video encoding and decoding system 10 that may perform techniques for enhanced reference picture management consistent with the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a wireless local area network connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for enhanced reference picture management described in this disclosure. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for enhanced reference picture management of reference pictures stored within the decoder picture buffer (DPB) described in this disclosure may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video pre-processor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20 of video encoding unit 21, which is also used by video decoder 30 of video decoding unit 29, that includes syntax elements that describe characteristics and/or processing of blocks and other coded units, e.g., groups of pictures (GOPs). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video coding standard, such as the High Efficiency Video Coding (HEVC) standard, also referred to as ITU-T H.265 or extensions thereto, such as the multi-view and/or scalable video coding extensions. Additionally, or alternatively, video encoder 20 and video decoder 30 may operate according to other proprietary or industry implementations and/or standards, such as the Joint Exploration Test Model (JEM) and/or Versatile Video Coding (VVC). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard, implementation, and/or scheme. Other examples of video coding standards include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable processing circuitry configured for encoder and/or decoder operation/functionality Examples of such encoder and/or decoder configured processing circuity include, but are not limited to, one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors (e.g., processing circuitry) to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

In general, according to, for example, ITU-T H.265, a video picture may be divided into a sequence of coding tree units (CTUs) (or largest coding units (LCUs)) that may include both luma and chroma samples. Alternatively, CTUs may include monochrome data (i.e., only luma samples). Syntax data within a bitstream may define a size for the CTU, which is a largest coding unit in terms of the number of pixels. A slice includes a number of consecutive CTUs in coding order. A video picture may be partitioned into one or more slices. Each CTU may be split into coding units (CUs) according to a quadtree. In general, a quadtree data structure includes one node per CU, with a root node corresponding to the CTU. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a CTU may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a CTU may be split, referred to as a maximum CU depth, and may also define a minimum size of the coding nodes. Accordingly, a bitstream may also define a smallest coding unit (SCU). This disclosure uses the term “block” to refer to any of a CU, prediction unit (PU), or transform unit (TU), in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and is generally square in shape. The size of the CU may range from 8×8 pixels up to the size of the CTU with a maximum size, e.g., 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs (or partitions of a CU) within a given CU defined for a partitioned CTU, although this may not always be the case. The TUs are typically the same size or smaller than the PUs (or partitions of a CU, e.g., in the case of intra prediction). In some examples, residual samples corresponding to a CU may be subdivided into smaller units using a quadtree structure known as a “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs) when predicted using inter-prediction. In general, a PU represents a spatial area corresponding to all or a portion of the corresponding CU, and may include data for retrieving and/or generating a reference sample for the PU. Moreover, a PU includes data related to prediction. When the CU is inter-mode encoded, one or more PUs of the CU may include data defining motion information, such as one or more motion vectors, or the PUs may be skip mode coded. Data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0 or List 1) for the motion vector.

Leaf-CUs may also be intra-mode predicted. In general, intra prediction involves predicting a leaf-CU (or partitions thereof) using an intra-mode. A video coder may select a set of neighboring, previously coded pixels to the leaf-CU to use to predict the leaf-CU (or partitions thereof).

A leaf-CU may also include one or more transform units (TUs). The transform units may be specified using an RQT (also referred to as a TU quadtree structure), as discussed above. For example, a split flag may indicate whether a leaf-CU is split into four transform units. Then, each TU may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, partitions of a CU, or the CU itself, may be collocated with a corresponding leaf-TU for the CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a CTU (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures, starting with a random access point (RAP) picture. A video sequence may include syntax data in a sequence parameter set (SPS) that includes characteristics of the video sequence. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, prediction may be performed for PUs of various sizes. Assuming that the size of a particular CU is 2N×2N, intra-prediction may be performed on PU sizes of 2N×2N or N×N, and inter-prediction may be performed on symmetric PU sizes of 2N×2N, 2N×N, N×2N, or N×N. Asymmetric partitioning for inter-prediction may also be performed for PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs to include quantized transform coefficients representative of the residual data for the CU. That is, video encoder 20 may calculate the residual data (in the form of a residual block), transform the residual block to produce a block of transform coefficients, and then quantize the transform coefficients to form quantized transform coefficients. Video encoder 20 may form a TU including the quantized transform coefficients, as well as other syntax information (e.g., splitting information for the TU).

As noted above, following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements (e.g., the various examples of respective data signalled to identify pictures for inter prediction reference that enable the enhanced reference picture management of the present disclosure) associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In general, video decoder 30 performs a substantially similar, albeit reciprocal, process to that performed by video encoder 20 to decode encoded data. For example, video decoder 30 inverse quantizes and inverse transforms coefficients of a received TU to reproduce a residual block. Video decoder 30 uses a signaled prediction mode (intra- or inter-prediction) to form a predicted block. Then video decoder 30 combines the predicted block and the residual block (on a pixel-by-pixel basis) to reproduce the original block. Additional processing may be performed, such as performing a deblocking process to reduce visual artifacts along block boundaries. Furthermore, video decoder 30 may decode syntax elements using CABAC in a manner substantially similar to, albeit reciprocal to, the CABAC encoding process of video encoder 20.

Video encoder 20 may further send syntax data, such as block-based syntax data, picture-based syntax data, and sequence-based syntax data, to video decoder 30, e.g., in a picture header, a block header, a slice header, or other syntax data, such as a sequence parameter set (SPS), picture parameter set (PPS), and/or video parameter set (VPS).

As will be explained in more detail below, video encoder 20 and/or video decoder 30, in accordance with the enhanced reference picture management schemes of the present disclosure, may respectively include a processor implemented in processing circuitry such that the processor is configured to code (e.g., encode or decode) at least two distinct and unique pictures of a single coded video sequence (CVS) of video data where each picture of the at least two pictures is associated with an identical picture order count (POC) value. Video encoder 20 and/or video decoder 30 may be further be configured to associate respective data with each of the at least two pictures of the single CVS and identify, for inclusion in a reference picture set, at least one picture among the at least two pictures based on the identical POC value associated with the at least two pictures and the respective data associated with the at least one picture.

This disclosure may generally refer to “signaling” certain information, such as syntax elements. The term “signaling” may generally refer to the communication of values syntax elements and/or other data used to decode encoded video data. That is, video encoder 20 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

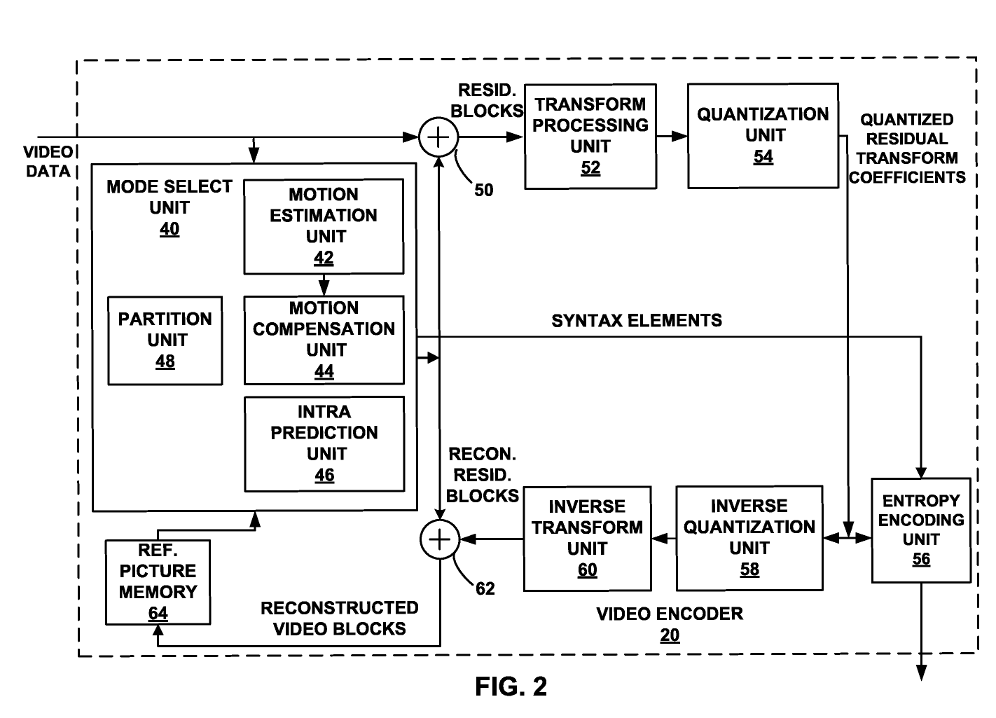

FIG. 2 is a block diagram illustrating an example of video encoder 20 that may implement techniques for enhanced reference picture management described in the present disclosure. FIG. 2 is provided for purposes of explanation and should not be considered limiting of the techniques as broadly exemplified and described in this disclosure. For purposes of explanation, this disclosure describes video encoder 20 in the context of video coding standards such as the HEVC video coding standard. However, the techniques of this disclosure are not limited to these video coding standards, and are applicable generally to video encoding and decoding including various codec implementations of future standards, for example, the VVC coding standard currently under development.

Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference picture memory 64 (which may also be referred to as a decoded picture buffer (DPB)), summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive encoding of the received video block relative to one or more blocks in one or more reference frames (e.g., references frames stored, utilized, and/or identified within the DPB in accordance with enhanced reference picture management techniques of the present disclosure) to provide temporal prediction. Intra-prediction unit 46 may alternatively perform intra-predictive encoding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into CTUs, and partition each of the CTUs into sub-CUs based on rate-distortion analysis (e.g., rate-distortion optimization). Mode select unit 40 may further produce a quadtree data structure indicative of partitioning of a CTU into sub-CUs. Leaf-node CUs of the quadtree may include one or more PUs and one or more TUs.

Mode select unit 40 may select one of the prediction modes, intra or inter, e.g., based on error results, and provides the resulting predicted block to summer 50 to generate residual data and to summer 62 to reconstruct the encoded block for use as a reference frame. Mode select unit 40 also provides syntax elements, such as motion vectors, intra-mode indicators, partition information, and other such syntax information (e.g., syntax elements indicative of respective data associated with individual pictures that may be indicative of whether a picture is to be output and/or a version identifier of the picture as described in detail below) to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), and/or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. In HEVC, for example, a reference picture is a picture that is a short-term reference picture or a long-term reference picture. A reference picture contains samples that may be used for inter prediction in the decoding process of subsequent pictures in decoding order. The reference picture may be selected from a first reference picture list (List 0) or a second reference picture list (List 1), each of which identify one or more reference pictures stored in reference picture memory 64. A reference picture list is a list of reference pictures that is used for inter prediction of a P or B slice. For the decoding process of a P slice, there is one reference picture list—reference picture list 0. For the decoding process of a B slice, there are two reference picture lists reference picture list 0 and reference picture list 1. Reference picture list 0 is used for inter prediction of a P or the first reference picture list used for inter prediction of a B slice. Reference picture list 1 is the second reference picture list used for inter prediction of a B slice. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements (e.g., respective data associated with individual pictures that may be indicative of whether a picture is to be output and/or a version identifier of the picture as described in detail below) associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes and/or intra prediction modes described in the present disclosure.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising transform coefficient values. Wavelet transforms, integer transforms, sub-band transforms, discrete sine transforms (DSTs), or other types of transforms could be used instead of a DCT. In any case, transform processing unit 52 applies the transform to the residual block, producing a block of transform coefficients. The transform may convert the residual information from a pixel domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain. In particular, summer 62 adds the reconstructed residual block to the motion compensated prediction block earlier produced by motion compensation unit 44 or intra-prediction unit 46 to produce a reconstructed video block for storage in reference picture memory 64. The reconstructed video block may be used by motion estimation unit 42 and motion compensation unit 44 as a reference block to inter-code a block in a subsequent video frame.

Video encoder 20 represents an example of a device configured to encode video data that includes a buffer memory configured to store pictures of the video data and at least one processor implemented in circuitry and in communication with the buffer memory, such that the at least one processor is configured to encode at least two distinct and unique pictures of a single coded video sequence (CVS) of video data where each picture of the at least two pictures is associated with an identical picture order count (POC) value. The at least one processor of video encoder 20 is further configured to associate respective data with each of the at least two pictures of the single CVS and identify, for inclusion in a reference picture set for performing inter prediction, at least one picture among the at least two pictures based on the identical POC value associated with the at least two pictures and the respective data associated with the at least one picture.

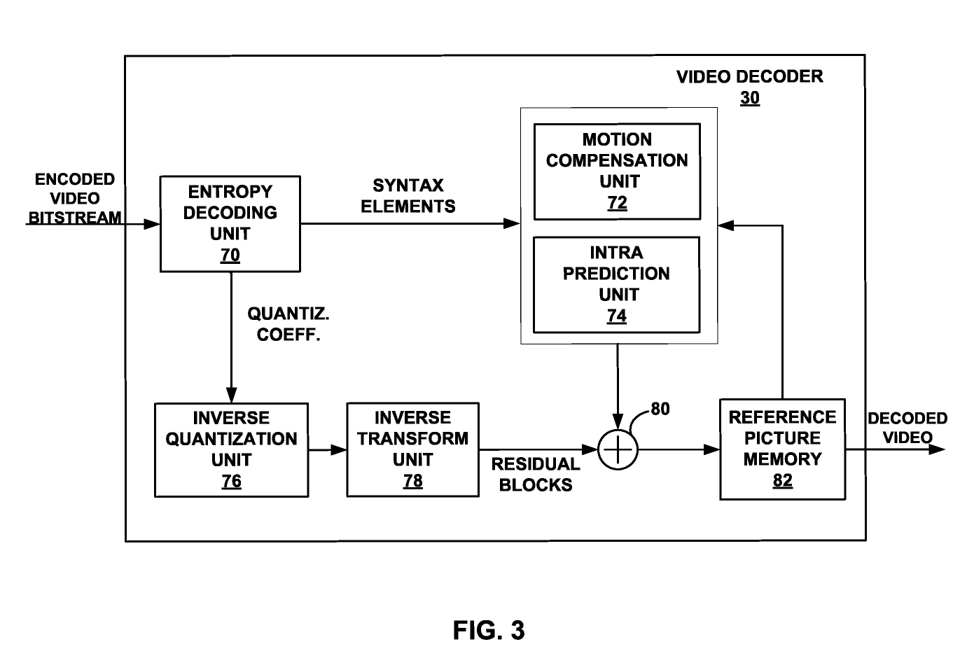

FIG. 3 is a block diagram illustrating an example of video decoder 30 that may implement techniques described in this disclosure. FIG. 3 is provided for purposes of explanation and is not limiting on the techniques as broadly exemplified and described in this disclosure. For purposes of explanation, this disclosure describes video decoder 30 is described according to HEVC. However, the techniques of this disclosure may be performed by video coding devices that are configured for other video coding standards and/or implementations such as JEM and VVC.

In the example of FIG. 3, video decoder 30 includes an entropy decoding unit 70, motion compensation unit 72, intra prediction unit 74, inverse quantization unit 76, inverse transformation unit 78, reference picture memory 82 (e.g., a DPB) and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements (e.g., syntax elements indicative of respective data associated with individual pictures that may be indicative of whether a picture is to be output and/or a version identifier of the picture as described in detail below). Entropy decoding unit 70 forwards the motion vectors and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B or P) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice or P slice), construction information (e.g., POC values and the respective data used for identifying pictures for inter prediction) for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QPy calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

In this manner, video decoder 30 represents an example of a video decoding device configured to decode video data that includes a buffer memory configured to store pictures of the video data and at least one processor implemented in circuitry and in communication with the buffer memory, such that the at least one processor is configured to decode at least two distinct and unique pictures of a single coded video sequence (CVS) of video data where each picture of the at least two pictures is associated with an identical picture order count (POC) value. The at least one processor of video decoder 30 is further configured to associate respective data with each of the at least two pictures of the single CVS and identify, for inclusion in a reference picture set for performing inter prediction, at least one picture among the at least two pictures based on the identical POC value associated with the at least two pictures and the respective data associated with the at least one picture.

Some DPB management techniques will now be described. According to some video coding techniques, various methods of DPB management may be implemented. As one example, decoded pictures used for predicting subsequent coded pictures, and for future output, may be buffered in a DPB. To efficiently utilize memory of a DPB, DPB management processes, including a storage process of decoded pictures into the DPB, a marking process of reference pictures, and output and removal processes of decoded pictures from the DPB, may be specified. DPB management may include at least the following aspects: (1) picture identification and reference picture identification; (2) reference picture list construction; (3) reference picture marking; (4) picture output from the DPB; (5) picture insertion into the DPB; and (6) picture removal from the DPB. Of the above processes, reference picture list construction (2) and reference picture marking (3) are typically collectively referred to as reference picture management. Some introduction to reference picture marking and reference picture list construction is provided below.

Reference Picture List Construction

According to some video coding techniques, various methods of reference picture list construction may be implemented. As one example, typically, a reference picture list construction for a first reference picture list or a second reference picture list of a “B” picture may include two steps: (1) reference picture list initialization, and (2) reference picture list reordering (which may be referred to as “modification”). The reference picture list initialization as performed by a video encoder and/or video decoder may be an explicit mechanism that puts (e.g., inserts as an entries) reference pictures in a reference picture memory (e.g., a decoded picture buffer “DPB”) into a list based on an order of picture order count (POC) values which are aligned with an output order, or a display order, of pictures.

The reference picture list reordering mechanism may modify a position of a picture that was put into the list during the reference picture list initialization to any new position, or put any reference picture in the reference picture memory in any position, even if the picture does not belong to the initialized list. Some pictures, after the reference picture list reordering (or modification), may be put in very “far” positions in the list. However, if the indicated size of the reference picture list is less than the number of entries in the reference picture list, the reference picture list may be truncated to fit (i.e., meet) the indicated size of the reference picture list. Furthermore, or alternatively, if a position of a picture exceeds a number of active reference pictures of the list, the picture may not be considered as an entry of the final reference picture list. The number of active reference pictures may be signaled within a slice header for each list.

The description above of with respect to reference picture list construction is applicable to both the AVC standard and the HEVC standard.

Reference Picture Marking in AVC

Reference picture list marking techniques will now be described. According to some video coding techniques, various methods of reference picture marking may be implemented. As one example, reference picture marking in H.264/AVC may be summarized as follows. A maximum number, which may be referred to as “M” (e.g., corresponding to syntax element num_ref_frames), of reference pictures used for inter-prediction may be indicated in an active sequence parameter set (SPS). When a reference picture is decoded, the reference picture may be marked as “used for reference.” If the decoding of the reference picture causes more than “M” pictures to be marked as “used for reference,” at least one picture must be marked as “unused for reference.” Subsequently, the DPB removal process may remove pictures marked as “unused for reference” from the DPB, if the pictures are also not needed for output.

When a picture is decoded, the picture may be either a non-reference picture, or a reference picture. A reference picture can be a long-term reference picture, or a short-term reference picture, and, when marked as “unused for reference,” the picture may become a non-reference picture.

H.264/AVC includes reference picture marking operations that change the status of reference pictures. For example, in H.264/AVC, there are two types of operations for the reference picture marking, namely the sliding window and the adaptive memory control which is also referred to as memory management control operation (MMCO). The operation mode for the reference picture marking is selected on a picture basis. As one example, the sliding window reference picture marking functions as a first-in-first-out (FIFO) queue with a fixed number of short-term reference pictures. In other words, a short-term reference picture with an earliest decoding time is first to be removed (i.e., marked as a picture “not used for reference”), in an implicit fashion. As another example, the adaptive memory control reference picture marking explicitly marks short-term pictures or long-term pictures. Adaptive memory control also enables switching the status of the short-term pictures and long-term pictures.

Reference Picture Marking in HEVC

Reference picture marking in H.265/HEVC may be summarized as follows. HEVC utilizes a reference picture management scheme based on reference picture sets (RPSs), of which reference picture marking is a part. A RPS is a set of reference pictures associated with a picture, consisting of all reference pictures that are prior to the associated picture in decoding order, that may be used for inter prediction of the associated picture or any picture following the associated picture in decoding order. The RPS of a picture consists of five RPS lists, three of which are to contain short-term reference pictures and the other two lists are to contain long-term reference pictures.

In accordance with the RPS-based reference picture management scheme, for each particular slice of a current picture, a complete set of the reference pictures that are used by the current picture or any subsequent picture must be provided. As such, a complete set of all pictures that must be kept (e.g., stored) in the DPB for use by the current picture or future picture(s) is signalled and received. In contrast, the reference picture marking techniques employed by AVC require only relative changes to the information stored in the DPB be signalled. With the RPS-based technique, no information from earlier pictures in decoding order is necessary/required to maintain the correct status of reference pictures stored in the DPB. As part of the signalling of the RPS-based technique, information indicative of whether a reference picture is to be used as a short-term reference picture or as a long-term reference picture is also explicitly signalled.

When a slice header of a picture has been parsed, a picture marking process is performed before (e.g., prior to) the slice data is decoded. Pictures that are present within the DPB and marked as “used for reference” but are not included in the RPS are marked “unused for reference.” After decoding the current picture, the current picture is marked as “used for short-term reference.”

Some potential problems with the above-described techniques will now be discussed. The various approaches described above, relating to existing reference picture management schemes, e.g., the schemes currently employed by video coding devices operating in accordance with H.264/AVC and H.265/HEVC, have several drawbacks. For example, existing reference picture management schemes do not allow for (or enable) multiple pictures (e.g., two unique, distinct pictures) to have a common (i.e., the same) POC value to be present (e.g., stored) in the DPB at the same time (e.g., concurrently stored in the DPB). For example, in the existing HEVC scheme, a picture order count (POC) is a variable that is associated with each picture that uniquely identifies the associated picture among all pictures in the CVS, and, when the associated picture is to be output from the DPB, that indicates the position of the associated picture in output order relative to the output order positions of the other pictures in the same CVS that are to be output from DPB. However, in several scenarios, it may be desirable to enable multiple pictures (e.g., two unique, distinct pictures) to have a common (i.e., the same) POC value to be present (e.g., stored) in the DPB at the same time. For example, future codecs, whether standardized or proprietary, may elect not to define or specify scalable, multi-view, and/or multi-layer extensions. In such cases, enabling a mechanism for storing, identifying, and selecting multiple pictures having the same POC value (which, for example, is representative of output order and/or output time) within a CVS, may be useful for processing different layers of a bitstream and may further be useful as tool for single layer bitstreams when applicable.

Furthermore, existing schemes do not allow for both pictures having the same, common POC value to be used for predicting (e.g., inter-predicting) other pictures at either the same time or at different times, with or without POC-based scaling of motion vectors and/or of sample values.

For example, in HEVC, it is required that, within one coded video sequence (CVS), the POC values for any two coded pictures shall not be the same. In HEVC, a CVS is a sequence of access units that consists, in decoding order, of an IRAP access unit with NoRaslOutputFlag equal to 1, followed by zero or more access units that are not IRAP access units with NoRaslOutputFlag equal to 1, including all subsequent access units up to but not including any subsequent access unit that is an TRAP access unit with NoRaslOutputFlag equal to 1. Note that an IRAP access unit may be an IDR access unit, a BLA access unit, or a CRA access unit. The value of NoRaslOutputFlag is equal to 1 for each IDR access unit, each BLA access unit, and each CRA access unit that is the first access unit in the bitstream in decoding order, is the first access unit that follows an end of sequence NAL unit in decoding order or has a HandleCraAsBlaFlag equal to 1. However, for highest coding efficiency, it would be desirable to enable coding schemes where multiple, distinct coded pictures are allowed to be associated with common, identical POC values. One example of such a coding scheme is as follows:

Two coded pictures are associated with the same, identical POC value.

The first coded picture (among the two coded pictures) was generated based on encoding a composed source picture. The composed source picture is a composition of one or more source pictures or their corresponding decoded pictures. In one example, the composed source picture is generated by weighted averaging the corresponding pixel values among the one or more source pictures or their decoded pictures. The source picture associated with the current POC value is defined as the target source picture and any source pictures associated with POC values other than the current POC value are regarded as the reference source pictures. In one example, the target source picture is divided into blocks and then a search for motion information is performed for each block to search for a similar reference block within the reference source pictures. For each block (“source block”) in the target source picture, N similar reference blocks (e.g. N can be any positive integer) together with the source block are weighted averaged to generate the final composed pixels for a corresponding block for the final composed source picture. The weightings may be pre-determined (e.g. equal weights) or may be adaptively determined (e.g., calculated) using the pixels between source block and reference blocks. For example, the weightings may be inversely proportional to the difference (e.g. Sum of Absolute Difference (SAD) or Sum of Square of Difference (SSD)) between the source block and reference blocks. In yet another example, each reference picture is divided into blocks and motion search is performed for each block to search for (e.g., identify) similar blocks within the target source picture. Each pixel in the target source picture together with (e.g., taken in combination with) similar pixels in the reference source pictures are weighted averaged to generate the final composed pixels for the final composed source picture for the current POC value.

The second coded picture (among the two coded pictures) associated with the same POC value may use the first coded picture as an inter prediction reference picture or vice versa.

The first coded picture may be indicated not to be output while the second coded picture may be indicated to be output.

Both the first and the second coded pictures may be used for inter prediction reference by other pictures, where POC-based scaling of motion vectors and/or sample values may be involved. However, note that, when the second coded picture uses the first coded picture for inter prediction reference, or vice versa, since both the first and second coded pictures are associated with the same POC value, POC-based scaling of motion vectors and/or sample values cannot be applied.

Another example is as follows:

Two coded pictures are associated with the same, identical POC value.

The first coded picture is associated with a lower coding quality than the coding quality associated with the second coded picture.

The second coded picture may use the first coded picture for inter prediction reference (i.e., the second coded picture maybe inter-predicted based on the first coded picture).

The first coded picture is indicated not to be output (e.g., from the DPB) while the second coded picture is indicated to be output.

Both the first and the second coded pictures may be used for inter prediction reference by other pictures, where POC-based scaling of motion vectors and/or sample values may be involved. However, note that, when the second coded picture uses the first coded picture for inter prediction reference (i.e., the second coded picture is inter-predicted based on the first coded picture), since the first and second coded pictures are associated with the same POC value, POC-based scaling of motion vectors and/or sample values cannot be applied.

In coding scenarios, for example, as in the two examples described above, it is important from a coding efficiency point of view to enable video coding devices to process multiple coded pictures with the same POC value within the same coded video sequence (CVS) and to enable their corresponding decoded pictures to be present in the DPB of the respective video coding device at the same time and used, by the video coding device, for inter-prediction in combination with POC-based scaling of motion vectors and/or sample values. However, note that, when a picture uses another picture for inter prediction reference, if both pictures have the same POC value, then POC-based scaling of motion vectors and/or sample values cannot be applied.

This disclosure describes one or more techniques that address the drawbacks described above. In particular, the technique(s) of this disclosure provide for some enhanced reference picture management methods utilized by a video coding device (e.g., video encoder 20 and/or video decoder 30) that enable multiple pictures having the same POC value to be present in the DPB at the same time and used for inter-prediction with POC-based scaling of motion vectors and/or sample values. It should be understood, that one or more of the techniques and/or embodiments of this disclosure may be applied independently, or in combination with other techniques and/or embodiments although all combinations are not explicitly discussed.

In accordance with one or more techniques of the present disclosure, it may be assumed that there may exist, in some embodiments of the present disclosure, two or more (e.g., in some cases at most two) coded pictures associated with the same POC value within a given CVS where each of the two coded pictures are respectively associated with different values of an output flag, the output flag being indicative of whether the associated coded picture is to be output or not to be output, such that the following technique(s) may be applied:

When a video coding device (e.g., video encoder 20 and/or video decoder 30) identifies (e.g., determines) one or more pictures to utilize for inter-prediction reference, including, for example, operations such as the necessary signalling for construction of the reference picture list(s) as well as for reference picture marking, these identified pictures may no longer be identified by respective POC values only but additionally identified, by the video coding device, by (e.g., in conjunction with) an associated value of the output flag such that a respective picture is identified using both a POC value and a value of the output flag. Consequently, in some embodiments within a particular CVS, the POC values for any two coded pictures shall not be the same unless the two coded pictures are respectively associated with different values of the output flag.

In the context, for example of HEVC, in signalling and derivation of reference picture sets, a video coding device (e.g., video encoder 20 and/or video decoder 30), in accordance with various embodiments of the present disclosure, may be configured to identify pictures by POC value and a value of the output flag. Once the video coding device derives a RPS in accordance with the present disclosure, existing HEVC reference picture list signalling and construction techniques/processes, as well as the reference picture marking process, may be utilized by the video coding device, as these processes are based on the RPS such that when a picture in the RPS needs to be identified, it is sufficient for the video coding device to “know” (e.g., determine or to access information indicative of) which of the RPS lists a given picture belongs to (e.g., which RPS list the given picture is associated with or is listed as entry within) and an index value associated with the given picture within that particular RPS list.

Alternatively, or additionally to the identification of pictures by POC value and a value of the output flag as discussed above, in accordance with one or more techniques of the present disclosure, it may be assumed that there may exist more than two coded pictures associated with the same POC value within a given CVS such that the following technique(s) may be applied:

In addition to a POC value (and in addition to, in some embodiments, a value of the output flag), a picture version identifier (PVID) may be explicitly signalled by a video coding device for each picture. The PVID may be indicative of a distinct (e.g., unique) version (or instance or copy or manifestation) of a given picture. For example, a syntax element (e.g., a syntax element referred to as “pic_ver_id”) may be signaled (e.g., in the bitstream including the video data or external to (e.g., separate from) the bitstream including the video data). Under certain circumstances or in accordance with certain criteria or condition(s), the PVID may be inferred (e.g., determined without receipt of signaled information) by a video coding device (e.g., the video encoder 20 and/or the video decoder 30). When a video coding device (e.g., video encoder 20 and/or video decoder 30) identifies (e.g., determines) one or more pictures to utilize for inter-prediction reference, including, for example, operations such as signalling necessary for construction of the reference picture list(s) as well as for reference picture marking, pictures may be identified by a respective POC value and an associated PVID value.

Consequently, within a CVS, in accordance with various embodiments of the present disclosure, the POC values for any two coded pictures shall not be the same unless the two coded pictures are respectively associated with different values of the PVID. In some embodiments, a video coding device (e.g., the video encoder 20 and/or the video decoder 30) may be configured, in accordance with a restriction or constraint, to only output a specified set of a plurality of pictures (e.g., a specified number of picture(s) or a specific picture(s) based on an identification mechanism) where each picture of the plurality of pictures is associated with the same POC value and where each picture of the plurality of pictures is associated with a different, respective value of the PVID. For example, the video coding device may be configure to only output the picture among the plurality of pictures associated with the same POC value that is associated with a specific (e.g., the greatest) PVID value.

In the context, for example, of HEVC, in signalling and derivation of a reference picture set (RPS), a video coding device, in accordance with various embodiments of the present disclosure, may be configured to identify pictures by POC value and a value of the PVID. Once a video coding device (e.g., video encoder 20 and/or video decoder 30) derives a RPS in accordance with the present disclosure, existing HEVC reference picture list signalling and construction techniques/processes, as well as the reference picture marking process, may be utilized by the video coding device, as these processes are based on the RPS such that when a picture in the RPS needs to be identified, it is sufficient for the video coding device to “know” (e.g., determine or to access information indicative of) which of the RPS lists a given picture belongs to (e.g., which RPS list the given picture is associated with or is listed as entry within) and an index value associated with the given picture within that particular RPS list.

As mentioned above, one or more of the techniques and/or embodiments of this disclosure may be applied independently, or in combination with other techniques and/or embodiments. As such, in some embodiments of the present disclosure, a video coding device (e.g., video encoder 20 and/or video decoder 30) may be configured to identify pictures by POC value, a value of the PVID, and/or a value of the output flag thereby enabling multiple pictures having the same POC value to be present in the DPB at the same time and additionally, in some implementations, used for inter-prediction with (and in some implementations without) POC-based scaling of motion vectors and/or of sample values.

Video encoder 20 and/or video decoder 30 may be configured in accordance with one or more embodiments that implement the techniques of the present disclosure as provided below. When certain portions of the HEVC specification are reproduced to illustrate the additions and deletions that may be incorporated to implement one or more of the methods described herein, additions are shown in bolding, underlined, and italicized text ( [symbol] ) and deletions are shown in strikethrough (example of deletion). Other parts of the HEVC specification not mentioned may be the same as provided in, for example, the current in-force, published version of the standard Recommendation ITU-T H.265 v4 (12/2016).

Alternatively, video encoder 20 and video decoder 30 may operate according to other proprietary or industry standards, such as JEM and/or VVC. The techniques of this disclosure, however, are not limited to any particular coding standard.

POC Signaling and Derivation

To allow two coded pictures within the same CVS to have the same POC value (e.g., “PicOrderCntVal”), the POC signalling syntax (e.g., slice_pic_order_cnt_lsb in the slice header syntax) and the POC derivation process (e.g., section 8.3.1 of the HEVC specification) may be implemented without modification. However, section 8.3.1 of the HEVC specification, the decoding process for picture order count may be modified as follows:

PicOrderCntVal is derived as follows:

PicOrderCntVal=PicOrderCntMsb+slice_pic_order_cnt_lsb (8-2)
NOTE 1—All IDR pictures will have PicOrderCntVal equal to 0 since slice_pic_order_cnt_lsb is inferred to be 0 for IDR pictures and prevPicOrderCntLsb and prevPicOrderCntMsb are both set equal to 0.

The value of PicOrderCntVal shall be in the range of −231 to 231−1, inclusive.

[symbol]

[symbol]

[symbol]

[symbol]

Additionally, the following constraint may be added (e.g., to section 8.3.1), or as part of the semantics of pic_output_flag, to enable a video coding device to uniquely identify one of the two pictures having the same POC value:

It is a requirement of bitstream conformance that, when there are two coded pictures having the same PicOrderCntVal value in a CVS, the values of pic_output_flag of the two coded pictures shall be different.

Reference Picture Set (RPS) Signalling and Derivation

In accordance with various embodiments implementing one or more techniques of the present disclosure, to enable signalling of non-zero delta POC values between two coded pictures with neighboring (including identical) POC values, the syntax of the st_ref_pic_set( ) syntax structure, for example, of section 7.3.7 (Short-term reference picture set syntax) may be changed as follows:

Descriptor

st_ref_pic_set( stRpsIdx ) {

...
} else {

| | |
|---|---|
| num_negative_pics | ue(v) |
| num_positive_pics | ue(v) |
| for( i = 0; i < num_negative_pics; i++ ) { | |

| | |
|---|---|
| delta_poc_s0 [symbol] [ i ] | ue(v) |
| [symbol] | [symbol] |
| used_by_curr_pic_s0_flag[ i ] | u(1) |

}
for( i = 0; i < num_positive_pics; i++ ) {

| | |
|---|---|
| delta_poc_s1 [symbol] [ i ] | ue(v) |
| [symbol] | [symbol] |
| used_by_curr_pic_s1_flag[ i ] | u(1) |

}

}

}

In section 7.4.8, the short-term reference picture set semantics may be modified as follows:

delta_poc_s0 [symbol] [i] plus 1, when i is equal to 0, specifies the difference between the picture order count values of the current picture and the i-th entry in the stRpsIdx-th candidate short-term RPS that has picture order count value less than or equal to that of the current picture, or, when i is greater than 0, specifies the difference between the picture order count values of the (i−1)-th entry and the i-th entry in the stRpsIdx-th candidate short-term RPS that have picture order count values less than or equal to the picture order count value of the current picture. The value of delta_poc_s0 [symbol] [i] shall be in the range of 0 to 2¹⁵−1, inclusive.
st_ref_Pic_s0_output_flag[i] indicates the value of pic_output_flag of the i-th entry in the stRpsIdx-th candidate short-term RPS that has picture order count value less than or equal to that of the current picture.
delta_poc_s1 [symbol] [i] [symbol] , when i is equal to 0, specifies the difference between the picture order count values of the current picture and the i-th entry in the stRpsIdx-th candidate short-term RPS that has picture order count value greater than that of the current picture, or, when i is greater than 0, specifies the difference between the picture order count values of the i-th entry and the (i−1)-th entry in the current candidate short-term RPS that have picture order count values greater than the picture order count value of the current picture. The value of delta_poc_s1 [symbol] [i] shall be in the range of 0 to 2¹⁵−1, inclusive.
st_ref_pic_s1_output_flag[i] indicates the value of pic_output_flag of the i-th entry in the stRpsIdx-th candidate short-term RPS that has picture order count value greater than that of the current picture.

Additionally, equations 7-67, 7-68, 7-69, and 7-70 in section 7.4.8 may be changed as follows:

DeltaPocS0[stRpsIdx][i]=delta_poc_s0 [symbol] [i] [symbol] (7-67)

DeltaPocS1[stRpsIdx][i]=delta_poc_s1 [symbol] [i] [symbol] (7-68)

DeltaPocS0[stRpsIdx][i]=DeltaPocS0[stRpsIdx][i−1]−delta_poc_s0 [symbol] [i] [symbol] (7-69)

DeltaPocS1[stRpsIdx][i]=DeltaPocS1[stRpsIdx][i−1]+delta_poc_s1 [symbol] [i] [symbol] (7-70)

Additionally, the following equations may be added to the specification:

PicOputFlagS0[stRpsIdx][i]=st_ref_pic_s0_outputflag[i]

PicOputFlagS1[stRpsIdx][i]=st_ref_pic_s1_outputflag[i]

Additionally, the syntax of the seq_parameter_set_rbsp( ) syntax structure may be changed as follows:

Descriptor

seq_parameter_set_rbsp( ) {

| | |
|---|---|
| ... | |
| num_short_term_ref_pic_sets | ue(v) |
| for( i = 0; i < num_short_term_ref_pic_sets; i++) | |

st_ref_pic_set( i )

| | |
|---|---|
| long_term_ref_pics_present_flag | u(1) |
| if( long_term_ref_pics_present_flag ) { | |

| | |
|---|---|
| num_long_term_ref_pics_sps | ue(v) |
| for( i = 0; i < num_long_term_ref_pics_sps; | |
| i++ ) { | |

| | |
|---|---|
| lt_ref_pic_poc_lsb_sps[ i ] | u(v) |
| [symbol] | [symbol] |
| used_by_curr_pic_lt_sps_flag[ i ] | u(1) |

}

}
...

}

The sequence parameter set semantics may be modified as follows:

lt_ref_pic_output_flag[i] indicates the value of pic_output_flag of the i-th candidate long-term reference picture specified in the SPS.

Additionally, the syntax of the slice_segment_header( ) syntax structure may be changed as follows:

De-
scrip-
tor

slice_segment_header( ) {

...

| | |
|---|---|
| slice_pic_order_cnt_lsb | u(v) |
| short_term_ref_pic_set_sps_flag | u(1) |
| if( !short_term_ref_pic_set_sps_flag ) | |

st_ref_pic_set( num_short_term_ref_pic_sets )

else if( num_short_term_ref_pic_sets > 1 )

| | |
|---|---|
| short_term_ref_pic_set_idx | u(v) |

if( long_term_ref_pics_present_flag ) {

if( num_long_term_ref_pics_sps > 0 )

| | |
|---|---|
| num_long_term_sps | ue(v) |

| | |
|---|---|
| num_long_term_pics | ue(v) |
| for( i = 0; i < num_long_term_sps + | |

num_long_term_pics; i++ ) {

if( i < num_long_term_sps ) {

if( num_long_term_ref_pics_sps > 1 )

| | |
|---|---|
| lt_idx_sps[ i ] | u(v) |

} else {

| | |
|---|---|
| poc_lsb_lt[ i ] | u(v) |
| [symbol] | [symbol] |
| used_by_curr_pic_lt_flag[ i ] | u(1) |

| | |
|---|---|
| } | |
| delta_poc_msb_present_flag[ i ] | u(1) |
| if( delta_poc_msb_present_flag[ i ] ) | |

| | |
|---|---|
| delta_poc_msb_cycle_lt[ i ] | ue(v) |

}

}

...

}

The slice segment header semantics may be modified as follows:

pic_output_flag_lt[i] indicates the value of pic_output_flag of the i-th entry in the long-term RPS of the current picture.
used_by_curr_pic_lt_flag[i] equal to 0 specifies that the i-th entry in the long-term RPS of the current picture is not used for reference by the current picture. The variables PocLsbLt[i], PofLt[i], and UsedByCurrPicLt[i] are derived as follows:
If i is less than num_long_term_sps, PocLsbLt[i] is set equal to lt_ref_pic_poc_lsb_sps[lt_idx_sps[i]], PofLt[i] is set equal to lt_ref_pic_output_flag[i], and UsedByCurrPicLt[i] is set equal to used_by_curr_pic_lt_sps_flag[lt_idx_sps[i]].
Otherwise, PocLsbLt[i] is set equal to poc_lsb_lt[i], PofLt[i] is set equal to pic_output_flag_lt[i], and UsedByCurrPicLt[i] is set equal to used_by_curr_pic_lt_flag[i].

Additionally, equation 8-5 in section 8.3.2 may be changed as follows:

```
  for( i = 0, j = 0, k = 0; i < NumNegativePics[ CurrRpsIdx ] ; i++ )
    if( UsedByCurrPicS0[ CurrRpsIdx ][ i ] ) [symbol]
      PocStCurrBefore[ j++ ] = PicOrderCntVal + DeltaPocS0
      [ CurrRpsIdx ][ i ]

[symbol]

[symbol]

    else [symbol]
      PocStFoll[ k++ ] = PicOrderCntVal + DeltaPocS0
      [ CurrRpsIdx ][ i ]

[symbol]

[symbol]


  NumPocStCurrBefore = j
  for( i = 0, j = 0; i < NumPositivePics[ CurrRpsIdx ]; i++ )
    if( UsedByCurrPicS1[ CurrRpsIdx ][ i ] ) [symbol]
      PocStCurrAfter[ j++ ] = PicOrderCntVal + DeltaPocS1
      [ CurrRpsIdx ][ i ]

[symbol]

[symbol]

    else [symbol]
      PocStFoll[ k++ ] = PicOrderCntVal + DeltaPocS1[ CurrRpsIdx ]
      [ i ]

[symbol]

[symbol]


  NumPocStCurrAfter = j
  NumPocStFoll = k  (8-5)
  for( i = 0, j = 0, k = 0; i < num_long_term_sps + num_long_term_pics;
  i++) {
    pocLt = PocLsbLt[ i ]
    if( delta_poc_msb_present_flag[ i ] )
      pocLt += PicOrderCntVal − DeltaPocMsbCycleLt[ i ] *
MaxPicOrderCntLsb −
        ( PicOrderCntVal & ( MaxPicOrderCntLsb − 1 ) )
    if( UsedByCurrPicLt[ i ] ) {
      PocLtCurr[ j ] = pocLt

[symbol]

      CurrDeltaPocMsbPresentFlag[ j++ ] =
      delta_poc_msb_present_flag[ i ]
    } else {
      PocLtFoll[ k ] = pocLt

[symbol]

      FollDeltaPocMsbPresentFlag[ k++ ] =
      delta_poc_msb_present_flag[ i ]
    }
  }
  NumPocLtCurr = j
  NumPocLtFoll = k
```

Additionally, equation 8-6 in section 8.3.2 may be changed as follows:

```
  for( i = 0; i < NumPocLtCurr; i++ )
  if( !CurrDeltaPocMsbPresentFlag[ i ] )
      if( there is a reference picture picX in the DPB
        withPicOrderCntVal & ( MaxPicOrderCntLsb − 1) equal to
        PocLtCurr[ i ], [symbol]
        and nuh_layer _id equal to currPicLayerId )
        RefPicSetLtCurr[ i ] = picX
      else
        RefPicSetLtCurr[ i ] = “no reference picture”
  else
      if( there is a reference picture picX in the DPB with
      PicOrderCntVal equal to
        PocLtCurr[ i ], [symbol]
        and nuh_layer_id
equal
        to currPicLayerId )
        RefPicSetLtCurr[ i ] = picX
      else
        RefPicSetLtCurr[ i ] = “no reference picture”
    (8-6)
  for( i = 0; i < NumPocLtFoll; i++ )
    if( !FollDeltaPocMsbPresentFlag[ i ] )
      if( there is a reference picture picX in the DPB with
        PicOrderCntVal & ( MaxPicOrderCntLsb − 1)
        equal to PocLtFoll[ i ] [symbol] [symbol]
        and nuh_layer_id equal to
        currPicLayerId )
        RefPicSetLtFoll[ i ] = picX
      else
        RefPicSetLtFoll[ i ] = “no reference picture”
    else
      if( there is a reference picture picX in the DPB with
      PicOrderCntVal equal to
        PocLtFoll[ i ], [symbol]
        and nuh_layer_id
equal to
        currPicLayerId )
        RefPicSetLtFoll[ i ] = picX
      else
        RefPicSetLtFoll[ i ] = “no reference picture”
```

Additionally, equation 8-7 in section 8.3.2 may be changed as follows:

```
for( i = 0; i < NumPocStCurrBefore; i++ )
  if( there is a short-term reference picture picX in the DPB
  with PicOrderCntVal
equal to
    PocStCurrBefore[ i ] [symbol]     and
      nuh_layer_id equal to currPicLayerId )
    RefPicSetStCurrBefore[ i ] = picX
  else
    RefPicSetStCurrBefore[ i ] = “no reference picture”
for( i = 0; i < NumPocStCurrAfter; i++ )
  if( there is a short-term reference picture picX in the DPB
  with PicOrderCntVal
equal to
    PocStCurrAfter[ i ], [symbol]
    and
nuh_layer_id  equal to currPicLayerId )
    RefPicSetStCurrAfter[ i ] = picX
  else
    RefPicSetStCurrAfter[ i ] = “no reference picture”
  (8-7)
for( i = 0; i < NumPocStFoll; i++ )
  if( there is a short-term reference picture picX in the DPB
  with PicOrderCntVal
equal to  PocStFoll[ i ] [symbol]
and
nuh_layer_id equal to currPicLayerId )
    RefPicSetStFoll[ i ] = picX
  else
    RefPicSetStFoll[ i ] = “no reference picture”
```

POC Signalling and Derivation

In various other embodiments that implement one or more techniques of the present disclosure, to allow two coded pictures within the same CVS to have the same POC value (e.g., “PicOrderCntVal”), the POC signalling syntax (e.g., slice_pic_order_cnt_lsb in the slice header syntax) and the POC derivation process (e.g., section 8.3.1 of the HEVC specification) may be implemented without modification. However, section 8.3.1 of the HEVC specification, the decoding process for picture order count may also be modified as follows:

PicOrderCntVal is derived as follows:

PicOrderCntVal=PicOrderCntMsb+slice_pic_order_cnt_lsb (8-2)
NOTE 1—All IDR pictures will have PicOrderCntVal equal to 0 since slice_pic_order_cnt_lsb is inferred to be 0 for IDR pictures and prevPicOrderCntLsb and prevPicOrderCntMsb are both set equal to 0.

The value of PicOrderCntVal shall be in the range of −231 to 231−1, inclusive. [symbol] [symbol] [symbol] [symbol] .

Signalling of PVID

In accordance with one or more techniques of the present disclosure, to enable signalling of PVID values associated with coded pictures, the syntax of the slice_segment_header( ) syntax structure may be changed as follows:

Descriptor

slice_segment_header( ) {

...

| | |
|---|---|
| slice_pic_order_cnt_lsb | u(v) |
| [symbol] | [symbol] |

...

}

The semantics of pic_ver_id may be as follows:

pic_ver_id specifies the picture version ID of the current picture. Pictures within a CVS having the same value of picture order count shall have different values of picture version ID.

Reference Picture Set (RPS) Signalling and Derivation

In accordance with various embodiments implementing one or more techniques of the present disclosure, to enable signalling of non-zero delta POC values between two coded pictures with neighboring (including identical) POC values, the syntax of the st_ref_pic_set( ) syntax structure may be changed as follows:

Descriptor

st_ref_pic_set( stRpsIdx ) {

...
} else {

| | |
|---|---|
| num_negative_pics | ue(v) |
| num_positive_pics | ue(v) |
| for( i = 0; i < num_negative_pics; i++ ) { | |

| | |
|---|---|
| delta_poc_s0 [symbol] [ i ] | ue(v) |
| [symbol] | [symbol] |
| used_by_curr_pic_s0_flag[ i ] | u(1) |

}
for( i = 0; i < num_positive_pics; i++ ) {

| | |
|---|---|
| delta_poc_s1 [symbol] [ i ] | ue(v) |
| [symbol] | [symbol] |
| used_by_curr_pic_s1_flag[ i ] | u(1) |

}

}

}

The short-term reference picture set semantics may be modified as follows:

delta_poc_s0 [symbol] [i] [symbol] plus 1, when i is equal to 0, specifies the difference between the picture order count values of the current picture and the i-th entry in the stRpsIdx-th candidate short-term RPS that has picture order count value less than or equal to that of the current picture, or, when i is greater than 0, specifies the difference between the picture order count values of the (i−1)-th entry and the i-th entry in the stRpsIdx-th candidate short-term RPS that have picture order count values less than or equal to the picture order count value of the current picture. The value of delta_poc_s0 [symbol] [i] shall be in the range of 0 to 2¹⁵−1, inclusive.
st_ref_pic_s0_pvid[i] indicates the value of pic_ver_id of the i-th entry in the stRpsIdx-th candidate short-term RPS that has picture order count value less than or equal to that of the current picture.
delta_poc_s1 [symbol] [i] [symbol] , when i is equal to 0, specifies the difference between the picture order count values of the current picture and the i-th entry in the stRpsIdx-th candidate short-term RPS that has picture order count value greater than that of the current picture, or, when i is greater than 0, specifies the difference between the picture order count values of the i-th entry and the (i−1)-th entry in the current candidate short-term RPS that have picture order count values greater than the picture order count value of the current picture. The value of delta_poc_s1 [symbol] [i] shall be in the range of 0 to 2¹⁵−1, inclusive. \
st_ref_pic_s1_pvid[i] indicates the value of pic_ver_id of the i-th entry in the stRpsIdx-th candidate short-term RPS that has picture order count value greater than that of the current picture.

Additionally, equations 7-67, 7-68, 7-69, and 7-70 may be changed as follows:

DeltaPocS0[stRpsIdx][i]=delta_poc_s0 [symbol] [i] [symbol] (7-67)

DeltaPocS1[stRpsIdx][i]=delta_poc_s1 [symbol] [i] [symbol] (7-68)

DeltaPocS0[stRpsIdx][i]=DeltaPocS0[stRpsIdx][i−1]−delta_poc_s0 [symbol] [i] [symbol] (7-69)

DeltaPocS1[stRpsIdx][i]=DeltaPocS1[stRpsIdx][i−1]+delta_poc_s1 [symbol] [i] [symbol] (7-70)

Additionally, the following equations may be added to the specification:

PicOputFlagS0[stRpsIdx][i]=st_ref_pic_s0_outputflag[i]

PicOputFlagS1[stRpsIdx][i]=st_ref_pic_s1_outputflag[i]

Additionally, the syntax of the seq_parameter_set_rbsp( ) syntax structure may be changed as follows:

Descriptor

seq_parameter_set_rbsp( ) {

| | |
|---|---|
| ... | |
| num_short_term_ref_pic_sets | ue(v) |
| for( i = 0; i < num_short_term_ref_pic_sets; i++) | |

st_ref_pic_set( i )

| | |
|---|---|
| long_term_ref_pics_present_flag | u(1) |
| if( long_term_ref_pics_present_flag ) { | |

| | |
|---|---|
| num_long_term_ref_pics_sps | ue(v) |
| for( i = 0; i < num_long_term_ref_pics_sps; | |
| i++ ) { | |

| | |
|---|---|
| lt_ref_pic_poc_lsb_sps[ i ] | u(v) |
| [symbol] | [symbol] |
| used_by_curr_pic_lt_sps_flag[ i ] | u(1) |

}

}
...

}

The sequence parameter set semantics may be modified as follows:

lt_ref_pvid[i] indicates the value of pic_ver_id of the i-th candidate long-term reference picture specified in the SPS.

Additionally, the syntax of the slice_segment_header( ) syntax structure may be changed as follows:

De-
scrip-
tor

slice_segment_header( ) {

...

| | |
|---|---|
| slice_pic_order_cnt_lsb | u(v) |
| [symbol] | [symbol] |
| short_term_ref_pic_set_sps_flag | u(1) |
| if( !short_term_ref_pic_set_sps_flag ) | |

st_ref_pic_set( num_short_term_ref_pic_sets )

else if( num_short_term_ref_pic_sets > 1 )

| | |
|---|---|
| short_term_ref_pic_set_idx | u(v) |

if( long_term_ref_pics_present_flag ) {

if( num_long_term_ref_pics_sps > 0 )

| | |
|---|---|
| num_long_term_sps | ue(v) |

| | |
|---|---|
| num_long_term_pics | ue(v) |
| for( i = 0; i < num_long_term_sps + | |
| num_long_term_pics; i++ ) { | |

if( i < num_long_term_sps ) {

if( num_long_term_ref_pics_sps > 1 )

| | |
|---|---|
| lt_idx_sps[ i ] | u(v) |

} else {

| | |
|---|---|
| poc_lsb_lt[ i ] | u(v) |
| [symbol] | [symbol] |
| used_by_curr_pic_lt_flag[ i ] | u(1) |

| | |
|---|---|
| } | |
| delta_poc_msb_present_flag[ i ] | u(1) |
| if( delta_poc_msb_present_flag[ i ] ) | |

| | |
|---|---|
| delta_poc_msb_cycle_lt[ i ] | ue(v) |

}

}

...

}

And the semantics of the slice segment header may be modified as follows:

pvid_lt[i] indicates the value of pic_ver_id of the i-th entry in the long-term RPS of the current picture.
used_by_curr_pic_lt_flag[i] equal to 0 specifies that the i-th entry in the long-term RPS of the current picture is not used for reference by the current picture. The variables PocLsbLt[i], PvidLt[i], and UsedByCurrPicLt[i] are derived as follows:
If i is less than num_long_term_sps, PocLsbLt[i] is set equal to
lt_ref_pic_poc_lsb_sps[lt_idx_sps[i]], PvidLt[i] is set equal to lt_ref_pvid[i], and UsedByCurrPicLt[i] is set equal to used_by_curr_pic_lt_sps_flag[lt_idx_sps[i]].
Otherwise, PocLsbLt[i] is set equal to poc_lsb_lt[i], PvidLt[i] is set equal to pvid_lt[i], and UsedByCurrPicLt[i] is set equal to used_by_curr_pic_lt_flag[i].

Additionally, equations 8-5 may be modified as follows:

```
for( i = 0, j = 0, k = 0; i < NumNegativePics[ CurrRpsIdx ] ; i++ )
  if( UsedByCurrPicS0[ CurrRpsIdx ][ i ] ) [symbol]
    PocStCurrBefore[ j++ ] = PicOrderCntVal + DeltaPocS0
    [ CurrRpsIdx ][ i ]

[symbol]

[symbol]

  else [symbol]
    PocStFoll[ k++ ] = PicOrderCntVal + DeltaPocS0[ CurrRpsIdx ][ i ]

[symbol]

[symbol]


NumPocStCurrBefore = j
for( i = 0,j = 0; i < NumPositivePics[ CurrRpsIdx ]; i++ )
  if( UsedByCurrPicS1[ CurrRpsIdx ][ i ] ) [symbol]
    PocStCurrAfter[ j++ ] = PicOrderCntVal + DeltaPocS1
    [ CurrRpsIdx ][ i ]

[symbol]

[symbol]

  else [symbol]
    PocStFoll[ k++ ] = PicOrderCntVal + DeltaPocS1[ CurrRpsIdx ][ i ]

[symbol]

[symbol]


NumPocStCurrAfter = j
NumPocStFoll = k  (8-5)
for( i = 0, j = 0, k = 0; i < num_long_term_sps + num_long_term_pics;
i++) {
  pocLt = PocLsbLt[ i ]
  if( delta_poc_msb_present_flag[ i ] )
    pocLt += PicOrderCntVal − DeltaPocMsbCycleLt[ i] *
    MaxPicOrderCntLsb −
      ( PicOrderCntVal & ( MaxPicOrderCntLsb − 1 ) )
  if( UsedByCurrPicLt[ i ] ) {
    PocLtCurr[ j ] = pocLt

[symbol]

    CurrDeltaPocMsbPresentFlag[ j++] = delta_poc_msb_present_flag[ i ]
  } else {
    PocLtFoll[ k ] = pocLt

[symbol]

    FollDeltaPocMsbPresentFlag[ k++ ] = delta_poc_msb_present_flag[ i ]
  }
}
NumPocLtCurr = j
NumPocLtFoll = k
```

Additionally, equation 8-6 may be modified as follows:

```
for( i = 0; i < NumPocLtCurr; i++ )
  if( !CurrDeltaPocMsbPresentFlag[ i ] )
    if( there is a reference picture picX in the DPB with
PicOrderCntVal & ( MaxPicOrderCntLsb − 1 )
        equal to PocLtCurr[ i ], [symbol]    and
nuh_layer_id equal to
        currPicLayerId )
      RefPicSetLtCurr[ i ] = picX
    else
      RefPicSetLtCurr[ i ] = “no reference picture”
  else
    if( there is a reference picture picX in the DPB with
    PicOrderCntVal equal to
PocLtCurr[ i ] [symbol] [symbol]
        and nuh_layer_id equal to
currPicLayerId )
      RefPicSetLtCurr[ i ] = picX
    else
      RefPicSetLtCurr[ i ] = “no reference picture”
  (8-6)
for( i = 0; i < NumPocLtFoll; i++ )
  if( !FollDeltaPocMsbPresentFlag[ i ] )
    if( there is a reference picture picX in the DPB with
PicOrderCntVal & ( MaxPicOrderCntLsb − 1 ) equal to PocLtFoll[ i ],

[symbol]

[symbol]

and nuh_layer_id equal to currPicLayerId )
      RefPicSetLtFoll[ i ] = picX
    else
      RefPicSetLtFoll[ i ] = “no reference picture”
  else
    if( there is a reference picture picX in the DPB with
    PicOrderCntVal equal to
PocLtFoll[ i ] [symbol] [symbol]
        and nuh_layer_id equal to
currPicLayerId )
      RefPicSetLtFoll[ i ] = picX
    else
      RefPicSetLtFoll[ i ] = “no reference picture”
```

Additionally, equation 8-7 is changed as follows:

```
for( i = 0; i < NumPocStCurrBefore; i++ )
  if( there is a short-term reference picture picX in the DPB
  with PicOrderCntVal equal to
      PocStCurrBefore[ i ], [symbol]
      and
nuh_layer_id
      equal to currPicLayerId )
    RefPicSetStCurrBefore[ i ] = picX
  else
    RefPicSetStCurrBefore[ i ] = “no reference picture”
for( i = 0; i < NumPocStCurrAfter; i++ )
  if( there is a short-term reference picture picX in the DPB
  with PicOrderCntVal equal to
      PocStCurrAfter[ i ], [symbol]
      and nuh_layer_id
      equal to currPicLayerId )
    RefPicSetStCurrAfter[ i ] = picX
  else
    RefPicSetStCurrAfter[ i ] = “no reference picture”
  (8-7)
for( i = 0; i < NumPocStFoll; i++ )
  if( there is a short-term reference picture picX in the DPB
  with PicOrderCntVal equal to
PocStFoll[ i ] [symbol]
        and nuh_layer_id
        equal to
currPicLayerId )
    RefPicSetStFoll[ i ] = picX
  else
    RefPicSetStFoll[ i ] = “no reference picture”
```

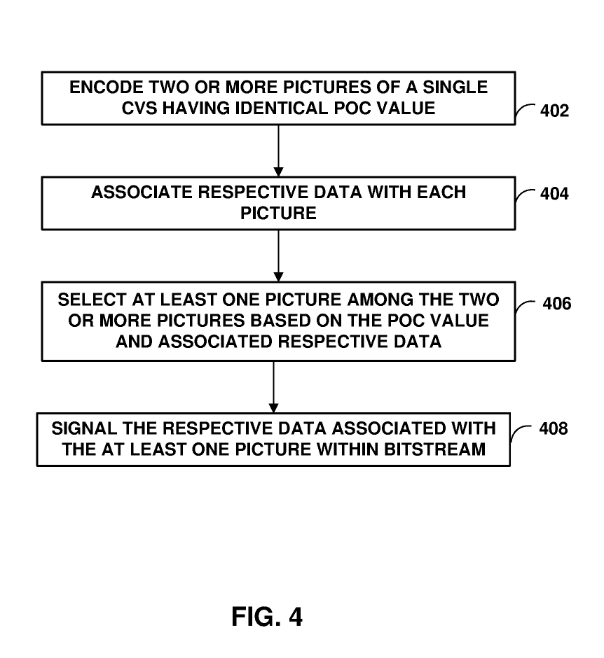

FIG. 4 is a flowchart illustrating example operations of a video encoder utilizing techniques associated with the enhanced reference picture management mechanism(s) of this disclosure. For purposes of explanation, the flowchart of FIG. 4 is described below as being performed by video encoder 20 and the components thereof as discussed in FIGS. 1 and 2. However, it should be understood that other devices may be configured to perform the flowchart of FIG. 4 or a similar method. Furthermore, the operations of the video encoder 20 described in conjunction with FIG. 4 are merely a subset of the operations video encoder 20 is configured to perform in accordance with the present disclosure. For example, video encoder 20 is configured to determine, process, and/or signal additional data (e.g., syntax elements) within an encoded bitstream and perform other operations (e.g., prediction of a current picture and POC-based scaling) described within the disclosure.

In accordance with one or more techniques of this disclosure, video encoder 20 (e.g., mode select unit 40 and components thereof) may encode two or more separate and distinct pictures of, for example, a particular CVS for use as reference pictures and associate a common (e.g., identical or shared) POC value with each of the two or more pictures (402). Video encoder 20 (e.g., mode select unit 40 and in some implementations, specifically motion estimation unit 42) may further associate (e.g., assign, configure, or set) and maintain respective information or data with each of the two more distinct pictures (404) in order to enable simultaneous storage of the two or more pictures of the particular CVS in the reference picture memory 64 such that at least one of the two or more pictures may be subsequently identified by, for example, motion compensation unit 44. In various embodiments, the respective information may include data indicative of whether a respective picture of the two or more pictures sharing an identical POC value is to be output and/or a version identifier of the respective picture.

Video encoder 20 (e.g., motion compensation unit 44) may identify (or select) at least one picture among the two or more pictures based on the identical, common POC value and the respective data associated with the at least one picture for purposes of inter prediction reference and derivation and/or construction of RPS(s) in accordance with the present disclosure (406).

The video encoder 20, in some embodiments, may explicitly signal (e.g., encode in the video bitstream including the particular CVS) the respective data as syntax elements in various syntax structures of the encoded bitstream (408). In other embodiments, the value(s) of a subset of the respective data may be inferred (e.g., implicitly derived by a video decoder) and therefore not explicitly signalled by the video encoder 20.

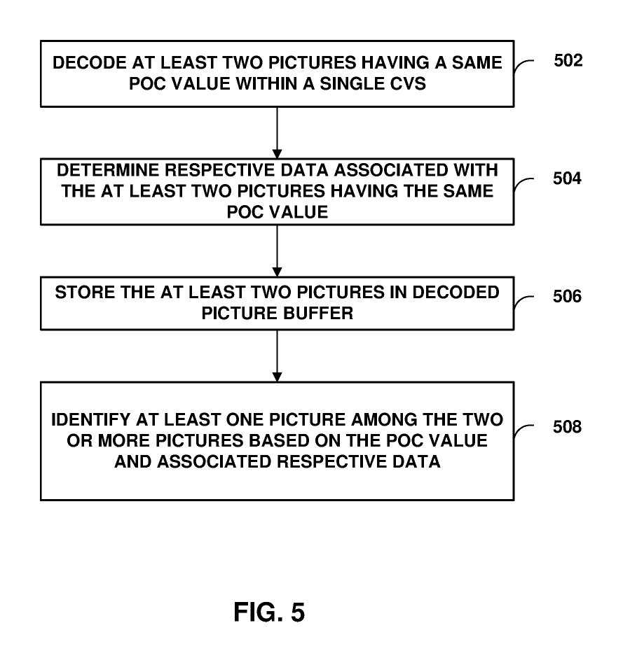

FIG. 5 is a flowchart illustrating example operations of a video decoder utilizing some of techniques/mechanisms of the enhanced reference picture management of the present disclosure. For purposes of explanation, the flowchart of FIG. 5 is described below as being performed by video decoder 30 and the components thereof as discussed in FIGS. 1 and 3. However, it should be understood that other devices may be configured to perform the flowchart of FIG. 5 or a similar method. Furthermore, the operations of the video decoder 30 described in conjunction with FIG. 5 are merely a subset of the operations video decoder 30 is configured to perform in accordance with the present disclosure. For example, video decoder 30 is configured to parse and process additional data (e.g., syntax elements) from a bitstream and perform other operations (e.g., prediction of a current picture and POC-based scaling) described throughout the disclosure.

Video decoder 30 decodes (e.g., reconstructs) at least two pictures within a single CVS (502). Video decoder 30 determines that the at least two pictures are associated with (e.g., assigned or identified by) an identical POC value. Video decoder 30 (e.g., motion compensation unit 72) further determines (and maintains) additional information used for identifying pictures for inter prediction reference (e.g., for derivation and/or construction of reference picture lists for decoding a current picture). For example, motion compensation unit 72 may determine (e.g., receive or derive) values of syntax elements and/or variables associated with each picture of the at least two pictures associated with the identical POC value (504). As discussed herein, in some embodiments, video decoder 30 may receive and/or locally determine (i.e., without receiving explicit signalling) data associated with each of that at least two pictures that indicates whether the picture is to be output and/or a version identifier of the picture.

Video decoder 30 may store the at least two pictures in the reference picture memory 82, also referred to herein as the DPB (506). In some implementations, the at least two pictures may be simultaneously present in the reference picture memory 82.

Video decoder 30 (e.g., motion compensation unit 72) may identify (or select) at least one picture among the two or more pictures based on the identical, common POC value and the respective data associated with the at least one picture for purposes of inter prediction reference and derivation and/or construction of RPS(s) for prediction of a subsequent picture (e.g., a current picture) to be decoded in accordance with the present disclosure (508).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of coding video data, comprising:
coding, by a coding device including a processor implemented in processing circuitry, at least two pictures of a single coded video sequence (CVS) of the video data, wherein each picture of the at least two pictures is associated with an identical picture order count (POC) value, the at least two pictures being different from one another;
associating, by the coding device, respective data with each of the at least two pictures of the single CVS; and
identifying, by the coding device for inclusion in a reference picture set, at least one picture among the at least two pictures based on the identical POC value associated with the at least two pictures and the respective data associated with the at least one picture.

2. The method of claim 1 further comprising storing, by the coding device, the at least two pictures in a buffer memory such that the at least two pictures are simultaneously present in the buffer memory at a given point in time.

3. The method of claim 1 further comprising one of signaling, receiving, or determining, by the coding device, the respective data associated with each of the at least two pictures of the single CVS within a bitstream comprising the single CVS.

4. The method of claim 3 further comprising one of signaling or receiving, by the coding device, the respective data associated with each of the at least two pictures of the single CVS within at least one of a parameter set syntax structure, slice header structure, or a reference picture set structure.

5. The method of claim 1 wherein the respective data is indicative of at least one of:
whether a picture of the at least two pictures is to be output, or
a version identifier of the picture of the at least two pictures.

6. The method of claim 1 further comprising including the identified at least one picture within the reference picture set.

7. The method of claim 6 further comprising predicting a current picture based on the identified at least one picture within the reference picture set.

8. The method of claim 1 further comprising performing POC-based scaling of at least one of motion information or of pixel values associated with the identified at least one picture for prediction of a current picture.

9. The method of claim 1 wherein coding the video comprises one of encoding or decoding the video data.

10. A coding device for coding video data, the device comprising:
a buffer memory configured to store pictures of the video data; and
at least one processor in communication with the buffer memory, the at least one processor being implemented in circuitry and configured to:
code, at least two pictures of a single coded video sequence (CVS) of the video data, wherein each picture of the at least two pictures is associated with an identical picture order count (POC) value, the at least two pictures being different from one another;
associate respective data with each of the at least two pictures of the single CVS; and
identify, for inclusion in a reference picture set, at least one picture among the at least two pictures based on the identical POC value associated with the at least two pictures and the respective data associated with the at least one picture.

11. The coding device of claim 10 wherein the at least one processor is further configured to store the at least two pictures in the buffer memory such that the at least two pictures are simultaneously present in the buffer memory at a given point in time.

12. The coding device of claim 10 wherein the at least one processor is further configured to one of signal, receive, or determine the respective data associated with each of the at least two pictures of the single CVS within a bitstream comprising the single CVS.

13. The coding device of claim 12 wherein the at least one processor is further configured to one of signal or receive the respective data associated with each of the at least two pictures of the single CVS within at least one of a parameter set syntax structure, slice header structure, or a reference picture set structure.

14. The coding device of claim 10 wherein the respective data is indicative of at least one of:
whether a picture of the at least two pictures is to be output, or
a version identifier of the picture of the at least two pictures.

15. The coding device of claim 10 wherein the at least one processor is further configured to include the identified at least one picture within the reference picture set.

16. The coding device of claim 15 wherein the at least one processor is further configured to predict a current picture based on the identified at least one picture within the reference picture set.

17. The coding device of claim 10 wherein the at least one processor is further configured to perform POC-based scaling of at least one of motion information or of pixel values associated with the identified at least one picture for prediction of a current picture.

18. The coding device of claim 10 wherein the coding device comprises one of an encoding device or a decoding device.

19. An apparatus configured to code video data, the device comprising:
means for storing pictures of the video data;
means for coding, at least two pictures of a single coded video sequence (CVS) of the video data, wherein each picture of the at least two pictures is associated with an identical picture order count (POC) value, the at least two pictures being different from one another;
means for associating respective data with each of the at least two pictures of the single CVS; and
means for identifying, for inclusion in a reference picture set, at least one picture among the at least two pictures based on the identical POC value associated with the at least two pictures and the respective data associated with the at least one picture.

20. The apparatus of claim 19 further comprising means for storing the at least two pictures in the buffer memory such that the at least two pictures are simultaneously present in the buffer memory at a given point in time.

21. The apparatus of claim 19 further comprising means for one of signaling, receiving, or determining the respective data associated with each of the at least two pictures of the single CVS within a bitstream comprising the single CVS.

22. The apparatus of claim 19 further comprising means for one of signaling or receiving the respective data associated with each of the at least two pictures of the single CVS within at least one of a parameter set syntax structure, slice header structure, or a reference picture set structure.

23. The apparatus of claim 19 wherein the respective data is indicative of at least one of:
whether a picture of the at least two pictures is to be output, or
a version identifier of the picture of the at least two pictures.

24. The apparatus of claim 19 further comprising means for including the identified at least one picture within the reference picture set.

25. The apparatus of claim 24 further comprising means for predicting a current picture based on the identified at least one picture within the reference picture set.

26. The apparatus of claim 19 further comprising means for performing POC-based scaling of at least one of motion information or of pixel values associated with the identified at least one picture for prediction of a current picture.

27. The apparatus of claim 19 wherein the apparatus comprises one of an encoding apparatus or a decoding apparatus.

28. A computer-readable storage medium storing instructions that, when executed, causes at least one processor configured to code video data to:
code at least two pictures of a single coded video sequence (CVS) of the video data, wherein each picture of the at least two pictures is associated with an identical picture order count (POC) value, the at least two pictures being different from one another;
associate respective data with each of the at least two pictures of the single CVS; and
identify, for inclusion in a reference picture set, at least one picture among the at least two pictures based on the identical POC value associated with the at least two pictures and the respective data associated with the at least one picture.

29. The computer-readable storage medium of claim 28, further storing instructions that, when executed, cause the at least one processor configured to code the video data to store the at least two pictures in a buffer memory such that the at least two pictures are simultaneously present in the buffer memory at a given point in time.

30. The computer-readable storage medium of claim 28, further storing instructions that, when executed, cause the at least one processor configured to code the video data to one of signal, receive, or determine the respective data associated with each of the at least two pictures of the single CVS within a bitstream comprising the single CVS.

31. The computer-readable storage medium of claim 28, further storing instructions that, when executed, cause the at least one processor configured to code the video data to one of signal or receive the respective data associated with each of the at least two pictures of the single CVS within at least one of a parameter set syntax structure, slice header structure, or a reference picture set structure.

32. The computer-readable storage medium of claim 28 wherein the respective data is indicative of at least one of:
whether a picture of the at least two pictures is to be output, or
a version identifier of the picture of the at least two pictures.

33. The computer-readable storage medium of claim 28, further storing instructions that, when executed, cause the at least one processor configured to code the video data to include the identified at least one picture within the reference picture set.

34. The computer-readable storage medium of claim 33, further storing instructions that, when executed, cause the at least one processor configured to code the video data to predict a current picture based on the identified at least one picture within the reference picture set.

35. The computer-readable storage medium of claim 28, further storing instructions that, when executed, cause the at least one processor configured to code the video data to perform POC-based scaling of at least one of motion information or of pixel values associated with the identified at least one picture for prediction of a current picture.
